(19) United States
(12) Patent Application Publication
(10) Pub. No.: US 2026/0289404 A1
(43) Pub. Date: Sep. 24, 2026

(54) LEARNING MODEL REGULARIZATION DEVICE, LEARNING MODEL REGULARIZATION METHOD, AND RECORDING MEDIUM

(71) Applicant: NEC Corporation, Tokyo (JP)

(72) Inventor: Yasuharu OKAMOTO, Tokyo (JP)

(73) Assignee: NEC Corporation, Tokyo (JP)

(21) Appl. No.: 19/474,321

(22) PCT Filed: Apr. 28, 2023
(86) PCT No.: PCT/JP2023/016884

§ 371 Date: Oct. 10, 2025

(51) Int. Cl. G06N 20/00

(52) U.S. Cl. CPC G06N 20/00

(57) ABSTRACT

The learning model regularization device 20 includes a first conversion unit 21 that converts a pre-conversion learning model, which is a learning model generated by a predetermined method and including a quantitative variable, into a post-conversion learning model, which is a learning model including a predetermined number of categorical variables that are 1 when the quantitative variable belongs to a certain category and to 0 when the quantitative variable does not belong to the certain category and a second conversion unit 22 that converts a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a QUBO model.

### TECHNICAL FIELD

The present invention relates to a learning model regularization device, a learning model regularization method, and a recording medium, and more specifically, to a learning model regularization device, a learning model regularization method, and a recording medium that utilize an Ising model and regularize a learning model by L0 regularization.

### BACKGROUND ART

As a method for constructing a learning model, there is Factorization Machines (FM), which constructs a learning model represented by a second-order polynomial composed of binary variables, as described in Non-Patent Literature 1.

In constructing a learning model with binary variables, training data corresponding to cross terms between features represented by one-hot vectors often does not exist. FM can address this issue by expanding features into latent vectors.

However, when FM is used, the latent vector expanded from feature A is, for example, common to both feature B and feature C. When the expanded latent vector is common to multiple different features, the descriptive performance of the learning model may be impaired.

Field-aware Factorization Machines (FFM), described in Non-Patent Literature 2, is a method for constructing a learning model that extends FM. FFM regards features as fields and assigns latent vectors to each field. When FFM is used, the descriptive performance of the learning model is improved.

However, the order of the number of learning parameters in FM is O(DK), where D is the number of features and K is the number of expansion terms of the latent vector. The order of the number of learning parameters in FFM is O(DFK), where D is the number of features, K is the number of expansion terms of the latent vector, and F is the number of fields. Here, O( ) represents order notation.

That is, when FFM is used, the number of learning parameters increases, so that the constructed learning model is more likely to suffer from overfitting. Developers who construct learning models using FFM are required to take measures so that the constructed learning models do not suffer from overfitting.

A general measure to prevent a constructed learning model from suffering from overfitting is to introduce a regularization term into the learning model. As methods for introducing a regularization term into a learning model, for example, L1 regularization, L2 regularization, or elastic net combining both, are used.

Patent Literature 1 describes an optimization device that enables accurate and high-speed sparse estimation.

Patent Literature 2 describes a feature selection device that uses an Ising machine and can select features that improve the analysis accuracy of a strong learner while reducing the number of selected features.

Non-Patent Literature 3 describes scikit-learn, a Python (registered trademark) module that widely integrates state-of-the-art machine learning algorithms for medium-scale supervised and unsupervised problems.

### CITATION LIST

### Patent Literature

PTL 1: Japanese Unexamined Patent Application Publication No. 2020-095397
PTL 2: WO 2018/235568

### Non-Patent Literature

NPL 1: S. Rendle, Z. Gantner, C. Freudenthaler and L. Schmidt-Thieme, “Fast Context-aware Recommendations with Factorization Machines,” Proceedings of the 34th International ACM SIGIR Conference on Research and Development in Information Retrieval, pages 635-644, 2011.
NPL 2: Y. Juan, Y. Zhuang, W.-S. Chin and C.-J. Lin, “Field-aware Factorization Machines for CTR Prediction,” Proc. 10th ACM Conf. Recommender Syst., pages. 43-50, 2016.
NPL 3: F. Pedregosa, et al., “Scikit-learn: Machine Learning in Python,” J. Mach. Learn. Res., 12, pages. 2825-2830, 2011.

### SUMMARY OF INVENTION

### Technical Problem

When L2 regularization is used, regularization is performed in such a way that almost all features contribute to the learning model, even when the regression coefficients themselves are small. Therefore, it becomes difficult for developers of the learning model to interpret the meaning of each term in the constructed learning model.

When L1 regularization is used, the regression coefficients after training often become sparse, thereby improving the problem in L2 regularization described above.

However, in L1 regularization, developers of the learning model are required to determine how much the regularization term contributes to the learning model by adjusting the learning parameters. That is, when L1 regularization is used, the burden on developers of the learning model increases. In addition, L1 regularization has a problem in that the number of non-zero regression coefficients cannot be controlled.

Therefore, as a method of introducing a regularization term into a learning model, it is conceivable to use L0 regularization instead of L1 regularization or L2 regularization. Patent Literatures 1 and 2 describe regularizing a learning model using L0 regularization.

However, when regularizing a learning model using an Ising model, it is necessary to convert quantitative variables in the learning model into binary variables. Patent Literatures 1 and 2 do not describe converting quantitative variables in the learning model.

Therefore, the present invention aims to provide a learning model regularization device, a learning model regularization method, and a recording medium capable of reducing the burden in regularizing a learning model having quantitative variables by L0 regularization.

### Solution to Problem

A learning model regularization device according to the present invention includes a first conversion unit that converts a pre-conversion learning model, which is a learning model generated by a predetermined method and including a quantitative variable, into a post-conversion learning model, which is a learning model including a predetermined number of categorical variables that are 1 when the quantitative variable belongs to the certain category and 0 when the quantitative variable does not belong to a certain category and a second conversion unit that converts a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

A learning model regularization method according to the present invention includes converting a pre-conversion learning model, which is a learning model generated by a predetermined method and including a quantitative variable, into a post-conversion learning model, which is a learning model including a predetermined number of categorical variables that are 1 when the quantitative variable belongs to a certain category and 0 when the quantitative variable does not belong to the certain category, and converting a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

A computer-readable recording medium storing a learning model regularization program according to the present invention causes a computer to execute a process including converting a pre-conversion learning model, which is a learning model generated by a predetermined method and including a quantitative variable, into a post-conversion learning model, which is a learning model including a predetermined number of categorical variables that are 1 when the quantitative variable belongs to a certain category and 0 when the quantitative variable does not belong to the certain category, and converting a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

### Advantageous Effects of Invention

According to the present invention, it is possible to reduce the burden in regularizing a learning model having quantitative variables by L0 regularization.

### BRIEF DESCRIPTION OF DRAWINGS

FIG. 1 It is a block diagram showing an example configuration of a learning model regularization device according to an example embodiment of the present invention.

FIG. 2 It is a flowchart showing operations of a learning model regularization process performed by learning model regularization device 100 according to the present example embodiment.

FIG. 3 It is an explanatory diagram showing the relationship between the number M_{f} of selected expanded features and coefficient of determination R² when all groups are aggregated.

FIG. 4 It is an explanatory diagram showing coefficients of determination for each group forming an age field.

FIG. 5 It is a scatter plot showing target values of training data and predicted values of a learning model regularized by learning model regularization device 100.

FIG. 6 It is a scatter plot showing target values of test data and predicted values of a learning model regularized by learning model regularization device 100.

FIG. 7 It is an explanatory diagram showing the relationship between weights as of expanded features and the number of groups in which the expanded features were selected.

FIG. 8 It is an explanatory diagram showing an example hardware configuration of learning model regularization device 100 according to the present invention.

FIG. 9 It is a block diagram showing an overview of the learning model regularization device according to the present invention.

### EXAMPLE EMBODIMENT

Hereinafter, an example embodiment of the present invention will be explained with reference to the drawings. First, an overview of a learning model regularization device according to the example embodiment of the present invention will be explained. The learning model regularization device of the present example embodiment is a device that regularizes a learning model having binary variables with values of 0 or 1 by L0 regularization.

When L0 regularization is used, developers of the learning model are required to set the total number of selected features and determine, for each feature, whether to select it. That is, L0 regularization is generally not used as a method to introduce a regularization term into a learning model because the implementation is complex.

However, learning models constructed by FM or FFM can be described in QUBO format. That is, learning models constructed by FM or FFM are suitable for optimization using the Ising model.

In other words, learning models constructed by FM or FFM are learning models that can be regularized by L0 regularization. Specifically, developers of the learning model can interpret the learning model based on the behavior of the learning model when the number of selected features is changed.

This is because, in L0 regularization, whether a feature is included in the learning model is determined for each feature. That is, compared to L1 regularization and L2 regularization, developers of the learning model can directly control the total number of selected features.

Moreover, the implementation of learning models constructed by FM or FFM becomes easier when quantitative variables in the learning model are divided by intervals and treated as categorical variables. When focusing on a specific field and optimizing based on each group forming the focused field, the learning model regularization device can select optimal features for each group at once. Furthermore, improvement in generalization performance can also be expected.

An example of describing a combinatorial optimization problem in QUBO format, which corresponds to the Ising model, will be explained below. When a combinatorial optimization problem is described in QUBO format, an equation representing the energy in the combinatorial optimization problem is generated. Next, the equation representing the energy in the combinatorial optimization problem is converted into an energy function of QUBO. QUBO is a model that represents the orientation of individual spins as “1” or “0”.

That is, the equation representing energy in the combinatorial optimization problem can be converted into the energy function in QUBO. This conversion method is publicly known. The energy function in QUBO is represented as shown in the following Equation (1).

$$\begin{matrix}[ Math . 1 ] & \\ {H}_{QUBO} = {\sum }_{ij} {Q}_{ij} {x}_{i} {x}_{j} & Equation ( 1 )\end{matrix}$$

In Equation (1), i and j are variables representing spins. Also, in Equation (1), xᵢ is a variable representing the orientation of spin i, and xⱼ is a variable representing the orientation of spin j. Qᵢⱼ in Equation (1) is a constant associated to the combination of spin i and spin j. Qᵢⱼ is defined as a constant for each combination of possible values of i and j.

When the energy function shown in Equation (1) is given and the combinatorial optimization problem is solved, the optimal orientation (1 or 0) of each spin is obtained. The obtained optimal orientation of each spin represents a solution to the combinatorial optimization problem.

### [Explanation of Configuration]

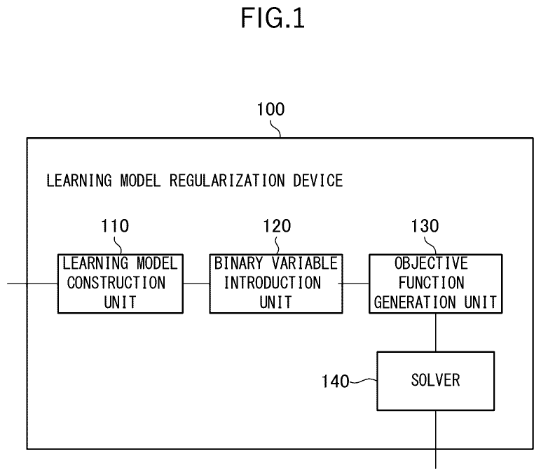

Hereinafter, a proposed method in which learning model regularization device 100 of the present example embodiment combines FFM and L0 regularization using the Ising model will be explained. FIG. 1 is a block diagram showing an example configuration of the learning model regularization device according to an example embodiment of the present invention.

As shown in FIG. 1, learning model regularization device 100 includes a learning model construction unit 110, a binary variable introduction unit 120, an objective function generation unit 130, and a solver 140.

Learning model construction unit 110 has a function to construct a learning model to be regularized. Learning model construction unit 110 constructs a learning model using, for example, FFM. Note that learning model construction unit 110 may also construct a learning model using a method other than FFM, such as FM.

When FFM is used, learning model construction unit 110 formulates a predicted value yᵢ\hat{ } for i-th data considering, for example, second-order interaction terms as follows.

$$\begin{matrix}[ Math . 2 ] & \\ {\hat{y}}_{i} = {w}_{0} + {\sum }_{l = 1}^{D} {w}_{l} {x}_{il} + {\sum }_{{l}_{2} > {l}_{1}}^{D} {w}_{{l}_{1} {l}_{2}} {x}_{{il}_{1}} {x}_{{il}_{2}} & Equation ( 2 )\end{matrix}$$

In Equation (2), xᵢₗ is a binary variable of 0 or 1 for the 1-th feature of the i-th data. That is, xᵢₗ in Equation (2) takes either 0 or 1.

Note that symbols such as “-”, “->”, and “A” used in this specification in the text should originally be written above the preceding character, but due to text formatting constraints, they are written immediately after the relevant character as shown. In equations, these symbols are written in their proper positions.

In Equation (2), w₀, w₁, and wₗ₁₁₂ are parameters determined by FFM. However, for the second-order parameter wₗ₁₁₂, learning model construction unit 110 uses the following inner product of latent vectors v->expanded into K terms. In the example described later, K=4.

$$\begin{matrix}[ Math . 3 ] & \\ {w}_{{l}_{1} {l}_{2}} \approx {\sum }_{m = 1}^{K} {v}_{{l}_{1} f ( {l}_{2} )}^{m} {v}_{{l}_{2} f ( {l}_{1} )}^{m} & Equation ( 3 )\end{matrix}$$

To optimize the parameters w₀, w₁, and v_{lf}^{m}, learning model construction unit 110 applies stochastic gradient descent to the residual sum of squares of Equation (2). In the present example embodiment, the learning rate n of the stochastic gradient descent is assumed by the following Equation (4).

$$\begin{matrix}[ Math . 4 ] & \\ η ( {n}_{e} ) = {a}_{1} exp ( - {a}_{2} \times {n}_{e} ) & Equation ( 4 )\end{matrix}$$

In Equation (4), ne is the number of epochs. In the example described later, the total number of epochs is 300. Also, a₁ and a₂ in Equation (4) are hyperparameters determined by cross-validation.

Binary variable introduction unit 120 has a function to introduce binary variables into the learning model. As described above, when FFM or optimization using the Ising model is applied, formulating the learning model becomes easier when the variables in the model are binary.

In Equation (2), a binary variable xᵢₗ is introduced such that when the i-th input data corresponds to the l-th feature item, then xᵢₗ=1, and when it does not correspond to the 1-th feature item, then xᵢₗ=0.

Further, binary variable introduction unit 120 of the present example embodiment introduces a binary variable p_{ig} such that when the i-th data determined from the input data belongs to group g of a focused field, then p_{ig}=1, and when not, p_{ig}=0. When binary variable p_{ig} is introduced, the residual Lᵢ is expressed as shown in the following Equation (5).

$$\begin{matrix}[ Math . 5 ] & \\ {ℒ}_{i} ≡ {y}_{i} - {\hat{y}}_{i} = {y}_{i} - {\sum }_{s , g} {α}_{s} {X}_{is} {p}_{ig} {q}_{sg} & Equation ( 5 )\end{matrix}$$

In Equation (5), Xᵢₛ is defined as shown in the following Equation (6).

$$\begin{matrix}[ Math . 6 ] & \\ {X}_{is} = \{ \begin{matrix}{x}_{is} & ( 1 \leq s \leq D ) \\ {x}_{{il}_{1}} {x}_{{il}_{2}} & ( D + 1 \leq s \leq D ( D + 1 ) / 2 )\end{matrix} & Equation ( 6 )\end{matrix}$$

Similarly, αₛ in Equation (5) is defined as shown in the following Equation (7).

$$\begin{matrix}[ Math . 7 ] & \\ {α}_{s} = \{ \begin{matrix}{w}_{s} & ( 1 \leq s \leq D ) \\ {w}_{{l}_{1}} {w}_{{l}_{2}} & ( D + 1 \leq s \leq D ( D + 1 ) / 2 )\end{matrix} & Equation ( 7 )\end{matrix}$$

In Equations (6) and (7), D is the number of features. Also, q_{sg} in Equation (5) is a binary variable subject to optimization by the Ising model. When group g selects a feature that is to be selected by the s-th Ising model (hereinafter referred to as an expanded feature), then q_{sg}=1; when group g does not select the s-th expanded feature, then q_{sg}=0. In the example described later, D=38.

Objective function generation unit 130 has a function to generate an objective function to be regularized based on the residual Lᵢ. For L0 regularization, objective function generation unit 130 is required to set a penalty function such that the total number of selected expanded features in each group becomes M_{f}.

Therefore, objective function generation unit 130 generates objective function F, which is to be optimized (minimized) using the Ising model, as shown in the following Equation (8).

$$\begin{matrix}[ Math . 8 ] & \\ ℱ = {\sum }_{i} {( {y}_{i} - {\sum }_{s , g} {α}_{s} {X}_{is} {p}_{ig} {q}_{sg} )}^{2} + A {\sum }_{g} {( {\sum }_{s} {q}_{sg} - {M}_{f} )}^{2} & Equation ( 8 )\end{matrix}$$

The second term on the right-hand side of Equation (8) represents the penalty function. A in Equation (8) is a parameter determining the strength of the penalty term.

In Equation (8), the condition that the number of selected features matches a preset value L is added to the loss function as a squared penalty function. That is, objective function generation unit 130 represents the regularization term by a penalty function that is a function indicating the condition for achieving L0 regularization and includes the binary variable q_{sg}.

The objective function shown in Equation (8) corresponds to the energy function shown in Equation (1). Specifically, the binary variable q_{sg} to be optimized by the Ising model corresponds to the binary variables xᵢ and xⱼ in Equation (1).

Further, yᵢ, Xᵢₛ, and p_{ig} in Equation (8) are determined from input data. Also, as is obtained from training by FFM. M_{f} is the number of features selected by L0 regularization. A is a parameter that determines the magnitude of the penalty function.

Therefore, variables other than q_{sg} in Equation (8) are already determined before optimization using the Ising model. Thus, expanded Equation (8) is composed of a constant term, first-order terms, and second-order terms related to binary variable q_{sg}, and hence corresponds to Equation (1).

Solver 140 has a function to solve the combinatorial optimization problem. That is, solver 140 selects a combination of values of binary variable q_{sg} that minimizes the generated objective function. By optimizing Equation (8), solver 140 can determine combinations including different features of equal count for each group. Solver 140 outputs the solution to the solved combinatorial optimization problem.

Learning model regularization device 100 of the present example embodiment first constructs a learning model using FFM or the like without considering regularization, that is, determines regression coefficients wₖ of the learning model. Next, learning model regularization device 100 selects L appropriate regression coefficients from among m regression coefficients wₖ by optimization using the Ising model.

Specifically, objective function generation unit 130 converts the problem of regularizing the learning model into a combinatorial optimization problem of selecting a combination of regression coefficients of the learning model that minimizes an objective function, which is a function of the sum of a loss function for the learning model and a regularization term by L0 regularization, and is described by a QUBO model.

Also, when solving the combinatorial optimization problem, solver 140 selects a combination of values of binary variable q_{sg} instead of selecting a combination of regression coefficients Wk. That is, objective function generation unit 130 reduces the combinatorial optimization problem, which is a problem of selecting a combination of regression coefficients wₖ of the learning model that minimizes the objective function shown in Equation (8), to a problem of selecting a combination of values of binary variable q_{sg} that minimizes the objective function.

### [Explanation of Operation]

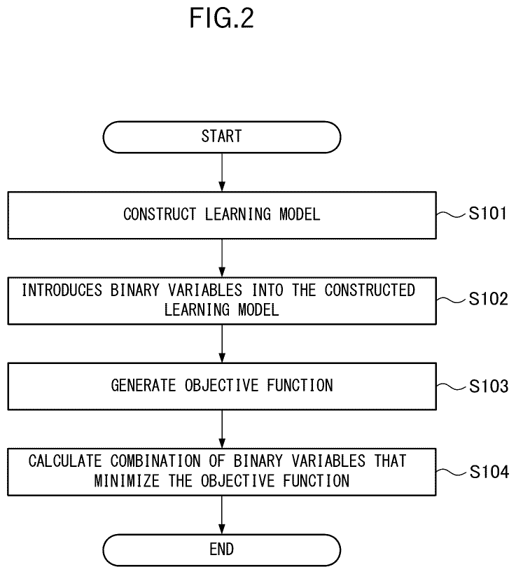

Hereinafter, operations for regularizing a learning model by learning model regularization device 100 of the present example embodiment will be explained with reference to FIG. 2. FIG. 2 is a flowchart showing operations of a learning model regularization process performed by learning model regularization device 100 according to the present example embodiment.

First, learning model construction unit 110 of learning model regularization device 100 constructs a learning model by a predetermined method (step S101).

Next, binary variable introduction unit 120 of learning model regularization device 100 introduces binary variables into the constructed learning model by a predetermined method (step S102).

Next, objective function generation unit 130 of learning model regularization device 100 generates an objective function based on the learning model having binary variables (step S103).

Next, solver 140 of learning model regularization device 100 calculates a combination of values of binary variables that minimizes the generated objective function (step S104). After the calculation, learning model regularization device 100 ends the learning model regularization process.

### [Explanation of Effects]

Learning model regularization device 100 of the present example embodiment is characterized in that L0 regularization using the Ising model is applied afterwards to a learning model constructed by FFM. Specifically, objective function generation unit 130 generates a combinatorial optimization problem that selects a combination of regression coefficients of the learning model that minimizes an objective function, which is a function of the sum of a loss function for the learning model and a regularization term based on L0 regularization, and is described by a QUBO model.

Further, solver 140 calculates a combination of regression coefficients (values of binary variables) that minimizes the generated objective function. Therefore, learning model regularization device 100 can easily examine the relationship between the number of features selected by the Ising model and generalization performance.

### Example

In the present example, a dataset described in Non-Patent Literature 3 is used, in which the relationship between ten features such as age, gender, BMI (Body Mass Index), and blood pressure values of diabetic patients and the severity of disease progression one year later is examined.

Also, in the present example, all 442 data in the dataset are randomly divided so that the ratio of training data to test data becomes 3:1. Furthermore, learning model construction unit 110 optimizes hyperparameters (learning rate) by performing 5-fold cross-validation and grid search on the training data.

In the present example, binary variable introduction unit 120 converts the remaining nine quantitative variables, excluding gender which corresponds to a categorical variable from the beginning in the diabetes data, into categorical variables (binary variables) such that each quantitative variable is composed of four groups.

Specifically, binary variable introduction unit 120 arranges the values of each quantitative variable in ascending order and divides them by quartiles. When the quantitative variables are converted into categorical variables, the number of features becomes 38 because only gender is divided into 2 groups while the remaining 9 quantitative variables are divided into 4 groups. Note that the number of fields remains 10.

When quantitative variables are converted into categorical variables based on quartiles, for example, the age field is divided into four groups: young, middle-aged A, middle-aged B, and elderly.

That is, binary variable introduction unit 120 converts a learning model having quantitative variables into a learning model having a predetermined number of categorical variables, where each categorical variable is set to 1 when the quantitative variable belongs to a certain category and set to 0 when it does not.

Also, the values of parameters w₀, w₁, and v_{11f(12)}^{m} determined by FFM are 1, 38, and 1520, respectively.

### Example 1

In Example 1, the coefficient of determination for the training data and test data was obtained when FFM was used alone. That is, regularization in the present example embodiment was not performed.

After determining the hyperparameters in Equation (4) by 5-fold cross-validation and grid search, the coefficient of determination for the test data was calculated. The calculated coefficient of determination was 0.4181. The coefficient of determination for the training data was 0.5768.

For comparison with the above results, two representative regularization methods, random forest (RF) and elastic net (EN), were selected, and calculations were performed on the same data under the same conditions. As a result, the coefficient of determination for the training data was 0.4122 in RF and 0.4863 in EN. The coefficient of determination for the test data was 0.4689 in RF and 0.4728 in EN.

As described above, the coefficient of determination for the training data when FFM was used alone exceeds that of both RF and EN. The reason is assumed to be that the number of features effectively increased due to the conversion of quantitative variables into categorical variables, thereby improving the descriptive performance of the learning model.

On the other hand, the coefficient of determination for the test data when FFM was used alone is lower than that of R^{F} and EN. The reason is assumed to be that regularization was not performed in Example 1.

### Example 2

The present example shows the relationship between the number of selected features in L0 regularization and generalization performance. In the present example, the optimal value of objective function F was calculated using FFM training data. Also, the binary variable q_{sg} that gives the optimal value was determined, and the determined q_{sg} was applied to test data to examine generalization performance.

Since there are 703 interaction terms, the number of expanded features that are subject to selection by the Ising model in Equation (8) in each group is 741. Furthermore, since a specific field is focused and optimization is performed for groups forming the focused specific field, the dimension of QUBO becomes 2964×2964 (=4×741).

A is set to 10. By setting A=10, the constraints on the number of selected features are satisfied in Examples 2 and 3.

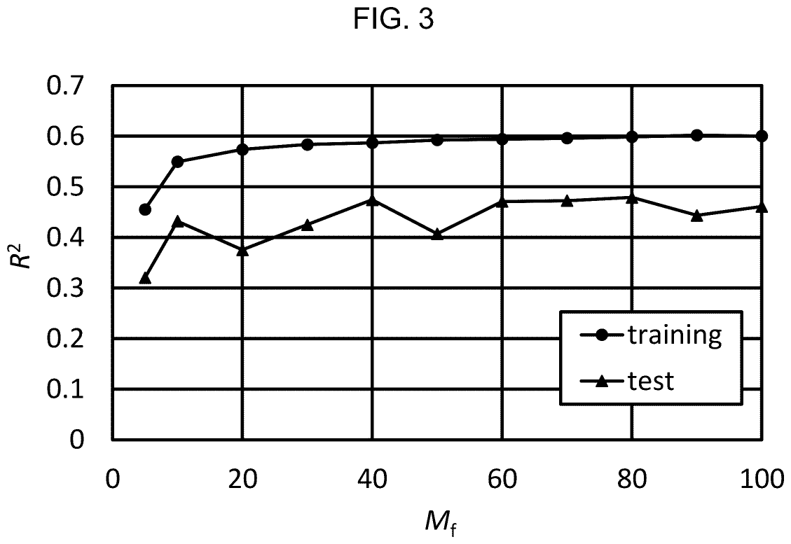

FIG. 3 is an explanatory diagram showing the relationship between the number M_{f} of selected expanded features and coefficient of determination R² when all groups are aggregated. FIG. 3 shows the transition of coefficients of determination for training data and test data when M_{f} is varied. Note that FIG. 3 shows the result for all groups combined, not for each individual group.

As shown in FIG. 3, when M_{f} is equal to or more than 30, the coefficient of determination for the test data with regularization becomes greater than that for the test data when FFM is used alone (0.4181). That is, when M_{f} is equal to or more than 30, generalization performance is improved.

In particular, when M_{f}={40, 60, 70, 80}, the coefficient of determination for the test data with regularization is comparable to that of RF (0.4689) and EN (0.4728). The maximum coefficient of determination for the test data with regularization was 0.4790 when M_{f}=80.

Also, as shown in FIG. 3, the coefficient of determination for the training data with regularization increases almost monotonically with M_{f}. Especially, when M_{f} is equal to or more than 30, the coefficient of determination for the training data with regularization exceeds the coefficient of determination for the training data when FFM is used alone (0.5768). That is, L0 regularization is also considered effective for training data.

In Example 2, the age field was focused, but learning model regularization device 100 can also easily select features based on groups forming other fields such as BMI.

### Example 3

Learning model regularization device 100 of the present example embodiment performs optimization for each group forming the focused specific field, so coefficients of determination for training data and test data can be obtained per group.

The present example shows generalization performance for each group forming the focused field. In this example, the age field was focused, as in Example 2.

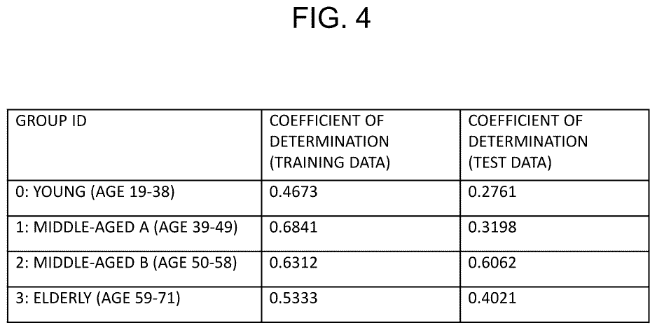

FIG. 4 is an explanatory diagram showing coefficients of determination for each group forming the age field. As shown in FIG. 4, the coefficient of determination for test data in group 0 (young) is particularly low.

Two possible reasons for the low coefficient of determination are considered. The first is that the age range of group 0 is wide, which may cause the test data to vary more than other groups.

The second reason is that the design of the original features may not have captured the characteristics of the young population sufficiently. The coefficient of determination for the training data in group 0 is also lower than that of other groups. Therefore, it is highly likely that the feature design itself may not be suitable for group 0.

As described above, learning model regularization device 100 of the present example embodiment can obtain information that is not easily acquired from training and test data alone.

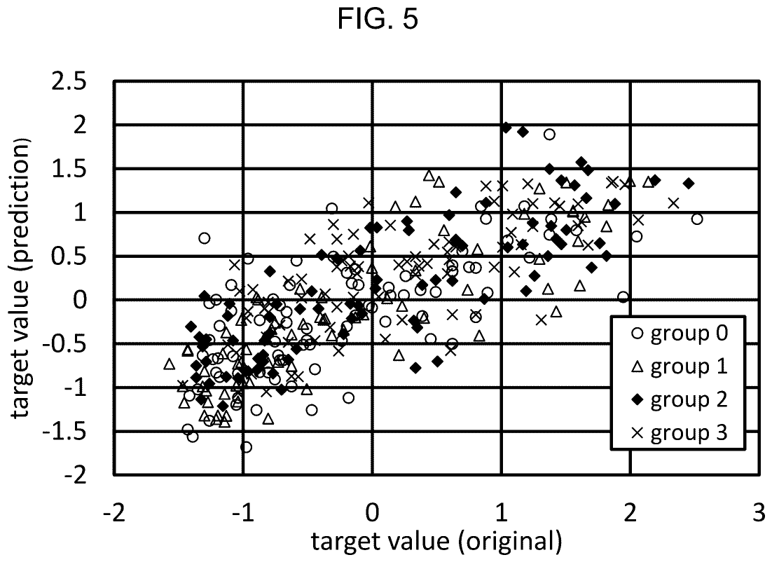

FIG. 5 is a scatter plot showing the target values of the training data and the predicted values of the learning model regularized by learning model regularization device 100. The horizontal axis in FIG. 5 indicates the target value representing the progression of diabetes after one year. The vertical axis in FIG. 5 indicates the predicted value of the learning model constructed by FFM and regularized by L0 regularization.

FIG. 5 also shows the target values and predicted values for the four groups forming the age field, distinguished by group. FIG. 5 shows standardized values.

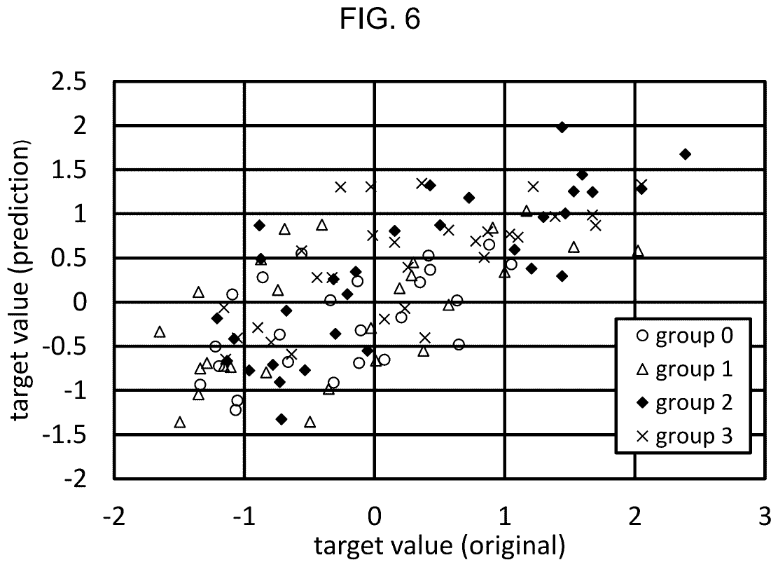

FIG. 6 is a scatter plot showing the target values of the test data and the predicted values of the learning model regularized by learning model regularization device 100. The meanings of the notations shown in FIG. 6 are the same as those shown in FIG. 5. FIG. 6 also shows standardized values.

As shown in FIG. 5, the relationship between the target values and predicted values of the training data is positively correlated. Also, as shown in FIG. 6, the relationship between the target values and predicted values of the test data is positively correlated.

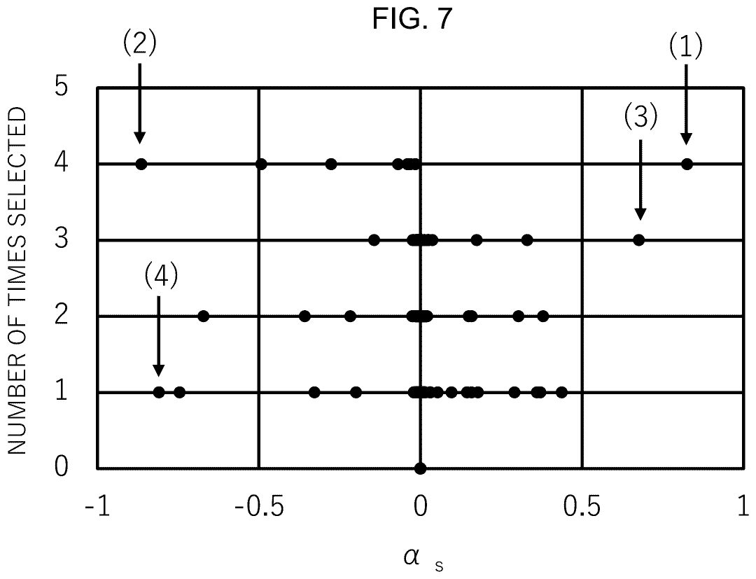

FIG. 7 is an explanatory diagram showing the relationship between the weight as of expanded features and the number of groups in which the expanded features were selected. as represents the entire regression coefficient of the learning model. Hereinafter, each point shown in FIG. 7 also represents a feature.

Points located on the vertical axis of as =0 represent features not selected in any group. There are 540 such features out of all 741 expanded features. There are 8 features selected in all groups.

For example, the point indicated by arrow (1) in FIG. 7 represents a feature selected in the group with the highest BMI. FIG. 7 shows that especially high obesity contributes significantly and positively to disease progression regardless of age group, that is, it tends to accelerate progression.

Also, the point indicated by arrow (2) in FIG. 7 represents a feature selected in the group with the lowest triglyceride level in blood. FIG. 7 shows that especially low triglyceride level contributes significantly and negatively to disease progression regardless of age group, that is, it tends to suppress progression.

The point indicated by arrow (3) in FIG. 7 represents a feature selected in the second highest BMI group in three of the four groups excluding group 1 (middle-aged A).

Features selected only in a single group are likely to reflect the uniqueness of that group. For example, the point indicated by arrow (4) in FIG. 7 represents a feature selected only in group 0 (female). FIG. 7 shows that in young females, there is a strong tendency for disease progression to be suppressed.

As described above, binary variable introduction unit 120 of the present example embodiment converts a pre-conversion learning model, which is a learning model having quantitative variables and generated by a predetermined method, into a post-conversion learning model, which is a learning model having a predetermined number of categorical variables, each of which is 1 when the quantitative variable belongs to a certain category and 0 when it does not.

Also, objective function generation unit 130 of the present example embodiment converts a problem of regularizing the pre-conversion learning model into a combinatorial optimization problem of selecting a combination of regression coefficients of the post-conversion learning model that minimizes an objective function, which is a function of the sum of a loss function for the post-conversion learning model and a regularization term by L0 regularization, and is described by a QUBO model.

Further, objective function generation unit 130 of the present example embodiment expresses the regularization term as a penalty function, which is a function indicating a condition for achieving L0 regularization and includes categorical variables. Objective function generation unit 130 reduces the combinatorial optimization problem to a problem of selecting a combination of values of the categorical variables that minimizes the objective function.

The predetermined method may be, for example, Factorization Machines. The predetermined method may also be Field-Aware Factorization Machines.

Solver 140 of the present example embodiment solves the converted combinatorial optimization problem. Solver 140 outputs the solution of the solved combinatorial optimization problem. Learning model construction unit 110 of the present example embodiment generates a learning model by a predetermined method.

Learning model regularization device 100 of the present example embodiment can extract an optimal combination of features for each category (young, middle-aged A, middle-aged B, elderly in the example) included in a focused field (age field in the example) at once by L0 regularization.

The optimal combination of features for each category can also be extracted by repeating the calculation process for the number of categories included in the focused field. However, learning model regularization device 100 of the present example embodiment can extract the optimal feature combinations at once, thereby reducing the burden of regularizing a learning model by L0 regularization.

Also, when learning model regularization device 100 of the present example embodiment is used, an optimal combination of features can be selected per category. Therefore, compared to a learning model in which features are selected without being divided by category, a model with higher accuracy, that is, better fitness to each category, is likely to be generated.

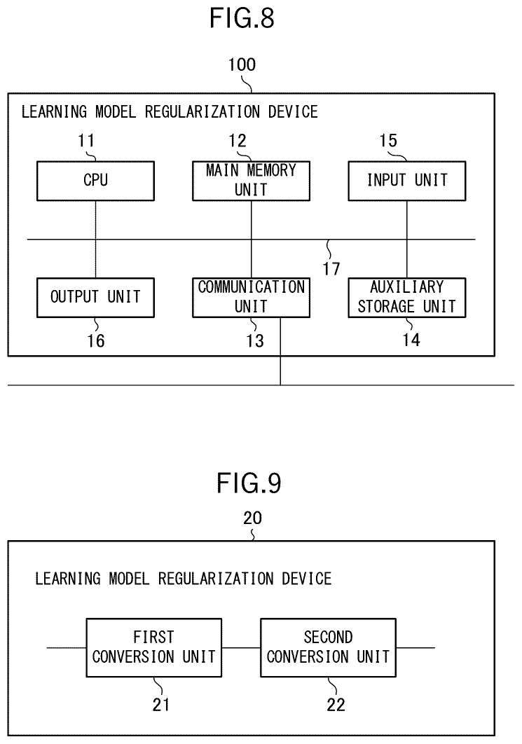

Hereinafter, a specific example of the hardware configuration of learning model regularization device 100 of the present example embodiment will be explained. FIG. 8 is an explanatory diagram showing an example hardware configuration of learning model regularization device 100 according to the present invention.

As shown in FIG. 8, learning model regularization device 100 includes a CPU (Central Processing Unit) 11, a main memory unit 12, a communication unit 13, and an auxiliary storage unit 14. It also includes an input unit 15 for user operation and an output unit 16 for presenting processing results or progress of processing to the user.

Learning model regularization device 100 is implemented in software by CPU 11 shown in FIG. 8 executing a program that provides the functions of each component.

That is, CPU 11 loads and executes the program stored in auxiliary storage unit 14 into main memory unit 12 to control the operation of learning model regularization device 100, whereby each function is implemented in software.

Note that learning model regularization device 100 shown in FIG. 8 may include a DSP (Digital Signal Processor) instead of CPU 11. Alternatively, learning model regularization device 100 may include both CPU 11 and DSP.

Main memory unit 12 is used as a working area for data and a temporary storage area for data. Main memory unit 12 is, for example, RAM (Random Access Memory).

Communication unit 13 has a function to input and output data with peripheral devices via a wired or wireless network (information communication network).

Auxiliary storage unit 14 is a non-transitory tangible storage medium. Examples of the non-transitory tangible storage medium include magnetic disks, magneto-optical disks, CD-ROMs (Compact Disk Read Only Memory), DVD-ROMs (Digital Versatile Disk Read Only Memory), and semiconductor memories.

Input unit 15 has a function to input data and processing instructions. Input unit 15 is, for example, an input device such as a keyboard, mouse, or touch panel.

Output unit 16 has a function to output data. Output unit 16 is, for example, a display device such as a liquid crystal display, a touch panel, or a printing device such as a printer.

As shown in FIG. 8, each component in learning model regularization device 100 is connected to system bus 17.

In learning model regularization device 100, auxiliary storage unit 14 stores programs for implementing learning model construction unit 110, binary variable introduction unit 120, objective function generation unit 130, and solver 140.

Learning model regularization device 100 may be implemented as a circuit including hardware components such as an LSI (Large Scale Integration) that implements functions like those shown in FIG. 1.

Alternatively, learning model regularization device 100 may be implemented by hardware that does not include computer functions using elements such as CPUs. For example, some or all components may be implemented by general-purpose circuits, dedicated circuits, processors, or combinations thereof. These may be configured by a single chip (such as the above-mentioned LSI) or by multiple chips connected via a bus. Some or all of the components may also be implemented by a combination of the circuits described above and programs.

Some or all components of learning model regularization device 100 may be configured by one or more information processing devices having an arithmetic unit and a storage unit.

When some or all of the components are implemented by a plurality of information processing devices or circuits, the devices or circuits may be arranged either centrally or in a distributed manner. For example, the information processing devices or circuits may be connected via a communication network in configurations such as a client-server system or a cloud computing system.

Next, an overview of the present invention will be explained. FIG. 9 is a block diagram showing an overview of the learning model regularization device according to the present invention. Learning model regularization device 20 according to the present invention includes a first conversion unit 21 (for example, binary variable introduction unit 120) that converts a pre-conversion learning model, which is a learning model generated by a predetermined method and including a quantitative variable, into a post-conversion learning model, which is a learning model including a predetermined number of categorical variables that are set to 1 when the quantitative variable belongs to a certain category and set to 0 when the quantitative variable does not belong to the certain category, and a second conversion unit 22 (for example, objective function generation unit 130) that converts a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a QUBO model.

Second conversion unit 22 may express the regularization term as a penalty function that includes categorical variables and indicates a condition for achieving L0 regularization, and may reduce the combinatorial optimization problem to a problem of selecting a combination of values of categorical variables that minimizes the objective function.

With such a configuration, the learning model regularization device can reduce the burden of regularizing a learning model having quantitative variables by L0 regularization.

The predetermined method may be Factorization Machines. The predetermined method may also be Field-Aware Factorization Machines.

Learning model regularization device 20 may include a solver (for example, solver 140) that solves the converted combinatorial optimization problem, and the solver may output the solution of the solved combinatorial optimization problem.

Learning model regularization device 20 may also include a generation unit (for example, learning model construction unit 110) that generates a learning model by a predetermined method.

With such a configuration, the learning model regularization device can reduce the burden of regularizing a learning model having quantitative variables by L0 regularization.

While the present invention has been explained with reference to the above example embodiment and examples, the present invention is not limited to the above. Various modifications in the structure and details of the present invention may be made by those skilled in the art within the scope of the present invention.

### REFERENCE SIGNS LIST

11: CPU
12: Main memory unit
13: Communication unit
14: Auxiliary storage unit
15: Input unit
16: Output unit
17: System bus
20, 100: Learning model regularization device
21: First conversion unit
22: Second conversion unit
110: Learning model construction unit
120: Binary variable introduction unit
130: Objective function generation unit
140: Solver

What is claimed is:

1. A learning model regularization device comprising:
a memory storing software instructions; and
one or more processors configured to execute the software instructions to:
convert a pre-conversion learning model, which is a learning model generated by a predetermined method and including a quantitative variable, into a post-conversion learning model, which is a learning model including a predetermined number of categorical variables that are 1 when the quantitative variable belongs to a certain category and 0 when the quantitative variable does not belong to the certain category; and
convert a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

2. The learning model regularization device according to claim 1, wherein
the one or more processors are configured to execute the software instructions to:
expresses the regularization term as a penalty function, the penalty function including categorical variables and indicating a condition for achieving the L0 regularization; and
reduces the combinatorial optimization problem to a problem of selecting a combination of values of the categorical variables that minimizes the objective function.

3. The learning model regularization device according to claim 1, wherein
the predetermined method comprises Factorization Machines.

4. The learning model regularization device according to claim 1, wherein
the predetermined method comprises Field-Aware Factorization Machines.

5. The learning model regularization device according to claim 1, wherein the one or more processors are further configured to execute the software instructions to
solve the converted combinatorial optimization problem, and
output a solution of the solved combinatorial optimization problem.

6. The learning model regularization device according to claim 1, wherein the one or more processors are further configured to execute the software instructions to
generate the learning model by the predetermined method.

7. A learning model regularization method performed by a computer and comprising:
converting a pre-conversion learning model, which is a learning model generated by a predetermined method and including a quantitative variable, into a post-conversion learning model, which is a learning model including a predetermined number of categorical variables that are 1 when the quantitative variable belongs to a certain category and 0 when the quantitative variable does not belong to the certain category; and
converting a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

8. The learning model regularization method according to claim 7, comprising:
expressing the regularization term as a penalty function, the penalty function including categorical variables and indicating a condition for achieving the L0 regularization; and
reducing the combinatorial optimization problem to a problem of selecting a combination of values of the categorical variables that minimizes the objective function.

9. A non-transitory computer-readable recording medium storing a learning model regularization program executable by a computer to perform processing comprising:
converting a pre-conversion learning model, which is a learning model generated by a predetermined method and including a quantitative variable, into a post-conversion learning model, which is a learning model including a predetermined number of categorical variables that are 1 when the quantitative variable belongs to a certain category and 0 when the quantitative variable does not belong to the certain category; and
converting a problem of regularizing the pre-conversion learning model into a combinatorial optimization problem of selecting a combination of regression coefficients of the post-conversion learning model that minimizes an objective function, the objective function being a function representing the sum of a loss function for the post-conversion learning model and a regularization term based on L0 regularization, and described by a Quadratic Unconstrained Binary Optimization (QUBO) model.

10. The non-transitory computer-readable recording medium according to claim 9, wherein the processing further comprises:
expressing the regularization term as a penalty function, the penalty function including categorical variables and indicating a condition for achieving the L0 regularization; and
reducing the combinatorial optimization problem to a problem of selecting a combination of values of the categorical variables that minimizes the objective function.

11. The learning model regularization device according to claim 2 wherein the one or more processors are further configured to execute the software instructions to
generate the learning model by the predetermined method.

12. The learning model regularization device according to claim 3 wherein the one or more processors are further configured to execute the software instructions to
generate the learning model by the predetermined method.

13. The learning model regularization device according to claim 4 wherein the one or more processors are further configured to execute the software instructions to
generate the learning model by the predetermined method.

14. The learning model regularization device according to claim 5 wherein the one or more processors are further configured to execute the software instructions to
generate the learning model by the predetermined method.
